(19) United States
(12) Patent Application Publication
(10) Pub. No.: US 2005/0091371 A1
(43) Pub. Date: Apr. 28, 2005

(54) Ingress points localization of a flow in a network

(75) Inventors: Gerard Delegue, Cachan (FR); Olivier Martinot, Draveil (FR); Stephane Betge-Brezetz, Paris (FR); Emmanuel Marilly, Saint-Michel-Sur-Orge (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/951,730

(22) Filed: Sep. 29, 2004

(30) Foreign Application Priority Data
Sep. 30, 2003 (FR) 03 11 410

(51) Int. Cl. G06F 15/173; H04Q 7/00

(52) U.S. Cl. 709/224; 709/223; 370/328

(57) ABSTRACT

A data flow detection device (DD), for an edge equipment element (RP) of a communication network equipped with a network management system, includes detection means (MA) tasked to compare parameters, which are contained in the headers of data packets arriving at the ingress interfaces (IE) of the edge equipment element (RP) associated respectively with interface identifiers, with at least one configuration parameter received from the network management system. In the event where a header parameter of a data packet received at one of the ingress interfaces (IE) is found to be identical with the configuration parameter, the detection means (MA) generate an alarm message, intended for the network management system, where this message includes the identifier of the ingress interface (IE) which has received the data flow and the identifier of the configuration parameter.

The invention concerns the area of communication networks, and more precisely the control of the access points of the flows of data packets to communication networks.

As the skilled in the art knows, the operator of a communication network is frequently confronted by situations in which he must know by which network edge equipment element (or ingress point or node) a data flow has entered into his network.

This is particularly the case when it concerns improving the engineering of traffic within a network. In fact it can happen that a network equipment element, such as a router, may be overloaded by data flows belonging to a specific service class associated with a quality of service (QoS) of the “gold” type. In this example, the operator must determine the origin of the data flows in order to re-route them and attempt to re-establish, as quickly as possible, the quality of the service to which the customers concerned is entitled from such data flows.

However, this is also the case when the network is subjected to attack, by a virus for example. In this event, the operator must also determine the origin of the data flows conducting the attack, in order to be able to block them as quickly as possible at their point(s) of entry into the network. At present, such an operation is very difficult to execute, even when the parameters (or characteristics) of the attacking data flows are known and one is in possession of the routing table of the network.

This is again the case when a problem occurs in a network, such as congestion at a node for example.

In the aforementioned situations, once the operator has determined each point of entry of a data flow, it must determine the ingress interface used at each of the said points of entry. To this end, the operator must determine the paths taken by the data flow by examining , skip after skip, the traces that it has left in the neighboring routers. Now if such traces do not exist, the operator is obliged to install protocol analyzers between the links of the network. At all events, the operator must perform many operations manually, during which the customers of its network are deprived of the quality of service to which they are entitled, and/or the network is left defenseless.

The purpose of the invention is therefore to improve the situation.

To this end, it proposes a device for the detection of a flow of data packets, for an edge equipment element in a communication network equipped with a network management system, including detection means tasked to compare the parameters, contained in the packet headers of the data flows which arrive at the ingress interfaces of the edge equipment element (associated respectively with interface identifiers), with at least one received configuration parameter from (or designated by) the network management system and associated with a parameter identifier. Thus, when a header parameter of a packet from a data flow received at one of the ingress interfaces of the edge equipment element is identical to the received (or designated) configuration parameter, the detection means generate an alarm message intended for the network management system, including the identifier of the ingress interface which has received this data flow and the parameter identifier.

In addition, the detection means are preferably arranged so as to stop comparing the content of the header fields with a chosen configuration parameter when they receive a message from the network management system requiring that this comparison should be stopped.

The configuration parameter can, for example, be composed of a source address and a destination address, or a protocol identifier, or a DSCP identifier.

Such a detection device can be installed in a unit that is intended to be connected to a network edge equipment element, such as an edge router, or indeed it can be incorporated directly into a network equipment element, such as an edge router.

The invention also proposes a location management device for a network management system of a communication network which includes edge equipment that is fitted with ingress interfaces intended to receive flows of data packets and associated respectively with interface identifiers.

This management device is characterized by the fact that it includes processing means tasked to generate configuration messages which include at least one configuration parameter and instructions requiring transmission, in the event of detection, of the identifier of the ingress interface having received a data flow which includes a packet whose header includes a parameter identical to the configuration parameter, for sending to at least some of the edge equipment of the network.

The management device can include a graphical interface allowing, in particular, a user to communicate a configuration parameter to its processing means, in order that they can generate a configuration message which includes this configuration parameter.

In a variant or as an addition, the management device can include extraction means tasked, when they receive a request to obtain a configuration parameter representing a data flow received by a network equipment element designated by an identifier, to gain access to the management information base (MIB) of this designated equipment element, storing certain parameters contained in the header of the packets of the received data flow, so as to extract at least one of these parameters and then to transmit it to the processing means in order that they can generate a configuration message which includes this configuration parameter.

In addition, when the network management system includes a memory (of network topology) storing edge equipment identifiers allowing access by the data flows to the network, then the processing means can be arranged, when they receive a configuration parameter representing a chosen data flow, to access this memory so as to determine the identifiers of the edge equipment to which the configuration messages containing the received configuration parameter must be transmitted, and then to transmit these configuration messages to the edge equipment concerned.

In a variant, the graphical interface can be capable of allowing a user to select, from a list of edge equipment, each edge equipment element required to perform a detection, and then to communicate each selected edge equipment element identifier to the processing means with a view to the generation of a configuration message which includes the said configuration parameter. In this event, the graphical interface is preferably coupled to a memory (of network topology) of the network management system in which the identifiers of the edge equipment are stored, allowing access by the data flows to the network.

The management device can also include collection means tasked, when they receive an alarm message arriving from an edge equipment element and which includes an ingress interface identifier and a configuration parameter identifier, to command the processing means to generate a message, for sending to this edge equipment element, requiring that detection of the data flows containing the received configuration parameter should be stopped. In this event, the management device can also include timing means tasked, every time the processing means receive a request for the generation of a stop message, to start the timing of a selected time period, and then, at the end of the timed period, to authorize the processing means to transmit this stop message to the edge equipment element concerned.

The invention also proposes a location management process for a communication network, consisting of:

determining at least one configuration parameter representing a data flow to be detected and associated with a parameter identifier,

configuring selected edge equipment elements in the network, in order that they compare parameters, contained in the headers of data packets arriving at their ingress interfaces, with the determined configuration parameter, and that in the event of a header parameter of a data packet received at one of their ingress interfaces being identical to this configuration parameter, they generate an alarm message for sending to network management system, which includes the identifier of the ingress interface which has received the data flow and the parameter identifier, and

in the event of receiving an alarm message coming from an edge equipment element and which includes an ingress interface identifier and a configuration parameter identifier, transmitting a message to the edge equipment elements concerned, requiring that detection of the data flows which include the configuration parameter should be stopped.

Other characteristics and advantages of the invention will appear on examination of the following detailed description, and of the appended drawings, in which:

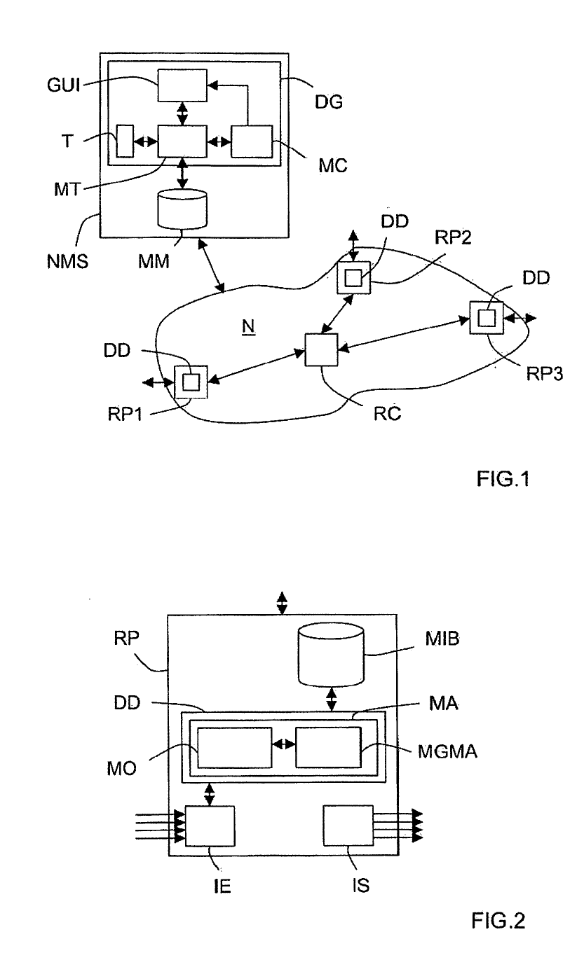

FIG. 1 schematically illustrates a communication network which includes a network management system (NMS) fitted with a first example of implementation of a location management device according to the invention, and network equipment fitted, at least in some cases, with a detection device according to the invention,

FIG. 2 schematically illustrates a network equipment element equipped with an example of implementation of a detection device according to the invention, and

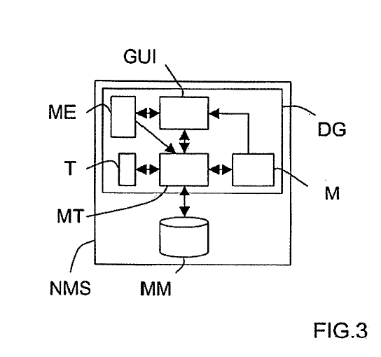

FIG. 3 schematically illustrates a second example of implementation of a location management device according to the invention.

The appended drawings can not only serve to complete the invention, but also to contribute to its specification, as appropriate.

The purpose of the invention is to allow the detection the ingress points of flows of data packets in managed communication networks. Here, “managed networks” refer to networks which include a network management system (NMS).

It is considered in what follows, by way of an illustrative example, that the communication network is at least partially of the Internet (IP) type. However, the invention also applies to other types of network, such as, for example, transmission networks of the WDM, SONET or SDH type, data networks of the ATM type, speech networks of the conventional or mobile type, or indeed mixed speech-data networks such as networks of the NGN type. It also applies to the transmission layer, and in particular to the TCP and UDP data flow and to the ICMP protocol.

Here, “IP network” refers to a multi-domain context composed of a collection of IP domains and/or subdomaines coupled to each other.

As illustrated very schematically in FIG. 1, an internet network (N) can be compared to a kernel which includes a set of network equipment (or nodes) (RPi and RC), connected together so as to perform the routing of data packets which they receive, and to a set of communication terminals (not shown), connected to certain network equipment (or nodes) (Rpi), possibly via one or more other terminals of the access server type, so as to exchange data packets with each other.

Here, “communication terminal” refers to any network equipment element capable of exchanging data packets, such as, for example, a portable or fixed computer, a fixed or mobile telephone, a personal digital assistant (PDA), or a server.

The network equipment elements (or nodes) are generally edge routers (Rpi, where i=1 to 3, but can take any value of two or more), and core routers. Only a single core router (RC) has been shown here, but there can be several.

Usually, the communication terminals are each connected to one of the edge routers (RPi), which acts as their access node to the internet network (N), and the edge routers (RPi) are generally connected together by means of one or more core routers (RC).

In addition, in a traditional IP network each domain or subdomain possesses its own edge routers (RPi) and its own core routers (RC). In a network of the IP/MPLS type, the network equipment elements are called “label switch routers” and come either in the form of routers or ATM switches controlled by a routing function.

The network (N) also includes a network management system (NMS) coupled, in particular, to its network equipment (RPi and RC). This network management system (NMS), also called a network operating system, particularly allows the manager (or supervisor) of the network to manage the network equipment (RPi and RC) of which it is composed.

To this end, the network equipment elements (RPi and RC) are arranged so as to be able to exchange data with the management system (NMS) in accordance with a network management protocol such as, for example, the RFC 2571-2580 simple network management protocol (SNMP). Of course, other network management protocols can be used equally well, and in particular the CLI, TL1, CORBA or CMISE/CMIP types.

As indicated in the introduction part, in many situations an operator must be able to determine not only each entry node (RP) by which a particular data flow has entered into its network (N), but also the ingress interface of this entry node. The invention is designed to allow such a determination.

To this end it proposes firstly a location management device (DG), illustrated in FIG. 1 and installed in the management system (NMS) of a network (N), and detection devices (DD) illustrated in FIG. 2 and installed in (or connected to) edge equipment (Rpi) of the network (N).

A detection device (DD), according to the invention, is intended to observe the data flows received by an edge equipment element, such as an edge router (RPi), in order to detect those which include packets whose headers include at least one chosen configuration parameter.

In what follows, we consider, by way of an illustrative example, that the detection devices (DD) are installed in edge routers (RPi). However, in a variant, they could include a unit intended to be coupled to an edge equipment element (Rpi).

As illustrated in FIG. 2, a detection device (DD) more precisely includes a detection module (MA) which preferably includes an observation module (MO) and an alarm message generation module (MGMA).

The observation (or filtering) module (MO) is coupled to the ingress interfaces (IE) of its edge router (RP), which are respectively associated with interface identifiers which allow them to be distinguished from each other. It is tasked to observe the data flows that its edge router (RP) receives on its interfaces (IE) in order to compare the parameters (or characteristics) contained in the packet headers in the received data flows with at least one configuration parameter received or designated by its (parameter) identifier.

As will be seen later, the configuration parameter or the configuration parameter identifier is transmitted to the edge routers concerned by the network management system (NMS) and more precisely by its location management device (DG).

The configuration parameter can be composed of a source address and a destination address, or indeed of a protocol identifier, or again of a DSCP identifier, for example. However, it can also be composed of a TCP or UDP header, or of a message type identifier in the case of the ICMP protocol.

Each packet in a data flow arriving at an ingress interface (IE) of an edge router (RPi), is therefore subjected to analysis of the parameters contained in its header fields. Thus when one of the header parameters of a received data packet is identical to the configuration parameter involved in the comparison, then the observation module (MO) alerts the alarm message generation module (MGMA). The latter then generates an alarm message, intended for the network management system (NMS), and more precisely intended for the location management device (DG), where this message includes the identifier of the ingress interface (IE) which has received this data flow and the identifier of the configuration parameter concerned.

As indicated above, the configuration parameters (or configuration parameter identifiers) are transmitted to the detection modules (MA) of the detection devices (DD) by the location management device (DG), via the network (N) and with the aid of commands which are suitable for the management protocol(s) of their respective edge routers (RPi) (SNMP or CLI for example).

To this end, the location management device (DG) includes, firstly, a processing module (MT) (also called a configuration module) tasked to generate configuration messages intended for at least some of the edge routers (RPi) of the network (N).

Each configuration message includes at least one configuration parameter (or its identifier) and instructions requiring a detection module (MA) which it configures itself, firstly, so as to filter (or compare) the content of the packet headers in the data flows received by its edge router (RPi), and secondly, so as to transmit the identifier of the ingress interface (IE) which has received a data flow that includes a packet whose header includes a parameter identical to the configuration parameter contained (or identified) in the configuration message.

In a manner of speaking then, a configuration message thus constitutes a data flow filter for use by a detection device (DD).

It is important to note that a given configuration message (or filter) can include several configuration parameters (or configuration parameter identifiers) which must be applied (or used) together. In addition, a given detection device (DD) can be arranged so as to use several filters in parallel, in order to monitor data flows presenting different characteristics (or parameters).

The configuration parameters (or their identifiers) can be supplied to the processing module (MT) in at least two ways.

A first way, illustrated in particular in FIG. 1, consists of equipping the location management device (DG) with a graphical user interface of the GUI type. In fact, such an interface (GUI) allows a user (such as a network administrator) to communicate one or more configuration parameters to the processing module (MT).

Where appropriate, it can also enable the administrator to select, from a list of edge routers (RPi), those to which the location management device (DG) must transmit the configuration messages containing an entered (or communicated) configuration parameter (or its identifier). In this event, the location management device (DG) is coupled to a memory (MM) which includes the specification of the topology of the network (N). This memory (MM) generally forms part of the management system (NMS), so that it is necessary only to couple it to the location management module (DG) for it to be able to use at least a part of its content.

Of course, it is not obligatory that the administrator alone should select the edge routers which must perform a detection. Assistance can be provided in this task by the processing module (MT). In this event, the processing module (MT) can, for example, propose a list of routers to the operator, who can then validate or refuse this list. To make this possible, the processing module (MT) must be coupled to the memory (MM).

In addition, the task can even be omitted when it is decided to always send each configuration message to all of the edge routers (RPi) in the network (N).

Once in possession of the configuration parameter, representing (or characteristic of) the data flow to be detected, and identifiers of the edge routers (RPi) required to effect the detection, the processing module (MT) then only has to generate its configuration message and have it transmitted by the network management system (NMS) to the said routers.

A second way, illustrated in FIG. 3, consists of equipping the location management device (DG) with a parameter extraction module (ME), coupled at least to the processing module (MT).

Such an extraction module (ME) is tasked, when it receives a request to obtain a configuration parameter representing a data flow which has been received by a network equipment element (RPi or RC), designated by its network identifier, to access its management information base (MIB), or indeed to connect to it (by a “login” procedure), in order to determine at least one of the parameters of the designated received data flow. The MIB is particularly useful, since it always stores certain parameters contained in the packet headers of the data flows which are received by its network equipment element (RPi or RC). In addition, it is directly accessible to the network management system (NMS).

Once the extraction module (ME) is in possession of the parameter(s) (or parameter identifier(s)) representing the designated data flow in the acquisition request, it can transmit it (or them) to the processing module (MT) in order that it should generate its configuration message. In a variant, and when the location management device (DG) is so arranged, the extraction module (ME) can transmit the parameters (or identifiers) extracted from the network equipment element (RPi or RC) to the graphical interface (GUI) so that the administrator can check and/or select at least one of them before communicating it to the processing module (MT) (after selection, where appropriate, of the edge routers (RPi) responsible for its (or their) detection).

Once in possession of the configuration parameter, representing (or characteristic of) the data flow to be detected, and of the identifiers of the edge routers (RPi) required to effect the detection (possibly after selection in the memory (MM)), the processing module (MT) then only has to generate its configuration message and to have it transmitted by the network management system (NMS) to the said routers.

The location management device (DG) can also include a collection module (MC) coupled to its processing module (MT), and preferably to its graphical interface (GUI) (when so equipped).

This collection module (MC) is tasked, when it receives an alarm message generated by the alarm generation module (MGMA) from an edge router (RPi) and which includes an ingress interface identifier (IE) and a configuration parameter identifier, to command the processing module (MT) to generate a message requiring that detection of the data flow characterized by this configuration parameter should be stopped.

In this embodiment, the processing module (MT) is therefore also arranged so as to generate a stop message intended for the edge equipment element (RPi) which has just detected a data flow whose packets include in their header the configuration parameter communicated by the collection module (MC). This enables the corresponding filtering at the edge router (RPi) concerned to be deactivated, and therefore prevention of its detection device (DD) from sending the same alarm message several times to indicate the arrival in its edge router (RPi) of a given data flow already detected.

In this event, the detection device (DD), and more precisely its observation module (MO), is arranged so as to deactivate the filter which includes the configuration parameter designated by a received stop message. Thus, once the filter has been deactivated, the observation module (MO) ceases to compare the packet headers with the corresponding configuration parameter. Of course, if other filters are still active, it continues its detection process with the latter, until such time as they are deactivated in their turn. The deactivation of filtering frees up processing time in the CPU at an edge equipment element (RPi) and therefore allows this CPU to be diverted to other tasks.

When the location management module (MG) is fitted with a graphical user interface (GUI), the collection module (MC) is advantageously tasked to send it a message indicating that it has received an alarm message indicating the entry into the network (N) of a data flow which includes a configuration parameter (identified by its identifier), at an ingress interface (identified by its identifier) of an edge router (RPi) (identified by its identifier). Since the administrator of the network (N) then knows the point of entry (or ingress interface (IE)) of the data flow, it can trigger appropriate actions with the aid of the network management system (NMS).

In addition, it is advantageous that the location management device (DG) should include a timer (T) coupled to its processing module (MT). This timer (T) is tasked to initiate the countdown of a chosen time period every time the processing module (MT) receives a request for the generation of a stop message on the part of the collection module (MC). When the countdown has ended, the timer (T) sends the processing module (MT) a message (or signal) authorizing it to transmit its stop message intended for the edge equipment element concerned.

In addition, the detection device (DD) of the edge equipment (Rpi) can possibly include a timer, preferably configurable by the management device (DG), in order to automatically deactivate a filtering process instituted previously when a chosen time period has expired.

The detection device (DD) according to the invention, and in particular at least a part of its observation module (MO) and its alarm message generation module (MGMA) on the one hand, and the location management device (DG), and in particular its processing module (MT), its extraction module (ME), its timer (T) and its collection module (MC) on the other, can be implemented in the form of electronic circuits, software (or computer) modules, or a combination of circuits and software.

With the aid of the invention, it is now possible to identify each point of entry of a chosen data flow into a network, rapidly and without manual analysis of data flow traces, allowing appropriate actions to be triggered much more rapidly that was possible previously, thus improving the security of the network in the event of attack, and consistency of the quality of service to which the customers of the network are entitled.

The invention is not limited to the embodiments of the detection device, of the location management device and of the location management process described above, by way of an example only, but it also encompasses all of the variants which could be envisaged by the professional engineer in the context of the following claims.

1. A detection device of flow of data packets (DD) for an edge equipment element (RP) of a communication network (N) equipped with a network management system (NMS), characterized in that it includes detection means (MA) arranged to compare parameters, contained in the headers of data packets arriving at the ingress interfaces (IE) of the said edge equipment element (RP), associated respectively with interface identifiers, with at least one configuration parameter received from the said network management system (NMS) and associated with a parameter identifier, and, in the event that a header parameter of a data packet received at one of the said ingress interfaces (IE) is identical to the said configuration parameter, of generating an alarm message intended for the said network management system (NMS), where this message includes the identifier of the ingress interface (IE) having received the said data flow and the said parameter identifier.

2. A device according to claim 1, characterized in that the said detection means (MA) are arranged to stop comparing the packet headers with a chosen configuration parameter in the event of receiving a message coming from the said network management system (NMS) and requiring that this comparison should be stopped.

3. A device according to claim 1, characterized in that the said configuration parameter is chosen from a group which includes at least source and destination addresses, a protocol identifier and a DSCP identifier.

4. A device according to claim 1, characterized in that it is installed in a unit capable of being connected to a network edge equipment element (RP).

5. A network edge equipment element (RP) for a communication network (N) fitted with a network management system (NMS), characterized in that it includes a detection device (DD) according to claim 1.

6. A network equipment element according to claim 5, characterized in that it is arranged in the form of an edge router.

7. A location management device (DG) for a network management system (NMS) of a communication network (N) which includes edge equipment elements (RP), equipped with ingress interfaces (IE) capable of receiving flows of data packets and associated respectively with interface identifiers, characterized in that it includes processing means (MT) arranged to generate configuration messages, for sending to least some of the said edge equipment (RP), where these messages include at least one configuration parameter and instructions requiring the transmission, in the event of detection, of the identifier of each ingress interface (IE) having received a data flow which includes a packet which includes, in a header, a parameter that is identical to the said configuration parameter.

8. A device according to claim 7, characterized in that it includes a graphical user interface (GUI) capable of allowing a user to communicate a configuration parameter to the said processing means (MT) with a view to the generation of a configuration message which includes the said configuration parameter.

9. A device according to claim 7, characterized in that it includes extraction means (ME) which are capable, in the event of receiving a request to obtain a configuration parameter representing a data flow received by an edge equipment element (RP) designated by an identifier, of accessing a management information base (MIB) of the said designated edge equipment element (RP), storing parameters contained in the packet headers of the data flows received, so as to extract at least one of the said parameters of the said received data flow and then transmitting it to the said processing means (MT) with a view to the generation of a configuration message which includes the said extracted parameter as a configuration parameter.

10. A device according to claim 7, characterized in that the said network management system (NMS) includes a memory (MM) which stores edge equipment identifiers (RP) allowing the data flows to enter the said network (N), where the said processing means (MT) are arranged, on receiving a configuration parameter representing a chosen data flow, to access the said memory (MM) so as to determine the identifiers of the edge equipment (RP) to which the configuration messages containing the said received configuration parameter must be transmitted, and then to transmit the said configuration message to each edge equipment element (RP) whose identifier has been determined.

11. A device according to claim 8, characterized in that the said graphical user interface (GUI) is capable of allowing a user to select, from a list of edge equipment (RP), each edge equipment element required to perform a detection process, and then to communicate each selected edge equipment element identifier to the said processing means (MT) with a view to the generation of a configuration message that includes the said configuration parameter.

12. A device according to claim 1 1, characterized in that the said graphical user interface (GUI) is coupled to a memory (MM) of the said network management system (NMS) storing the said edge equipment identifiers (RP) allowing access by the data flows to the said network (N).

13. A device according to claim 7, characterized in that it includes collection means (MC) which are capable, in the event of receiving an alarm message coming from an edge equipment element (RP) and which includes an ingress interface identifier (IE) and a configuration parameter identifier, of ordering the said processing means (MT) to generate a message, intended for the said edge equipment element (RP), requiring that detection of the data flows which includes the said received configuration parameter should be stopped.

14. A device according to claim 13, characterized in that it includes timing means (T) arranged, in the event of receipt by the said processing means (MT) of a request for the generation of a stop message, to start the countdown of a chosen time period, and then at the end of the timed period, to authorize the said processing means (MT) to transmit the said stop message intended for the said edge equipment element (RP) concerned.

15. A device according to claim 7, characterized in that the said configuration parameter is chosen from a group which includes at least source and destination addresses, a protocol identifier and a DSCP identifier.

16. A location management process for a communication network (N) which includes edge equipment (RP), equipped with ingress interfaces (IE) capable of receiving flows of data packets and associated respectively with interface identifiers, characterized in that it consists of:
determining at least one configuration parameter representing a data flow to be detected and associated with a parameter identifier,
configuring chosen edge equipment (RP) in the said network (N) so that they compare parameters, contained in the headers of data packets arriving at their ingress interfaces (IE), with the said configuration parameter, and so that, in the event of a header parameter of a data packet received at one of their ingress interfaces (IE) being identical to the said configuration parameter, they generate an alarm message, intended for a management system of the said network (NMS), where this message includes the identifier of the ingress interface (IE) having received the said data flow and the said parameter identifier, and
in the event of receiving an alarm message coming from an edge equipment element (RP) and which includes an ingress interface identifier (IE) and a configuration parameter identifier, of transmitting a message to the edge equipment (RP) concerned requiring that detection of the data flows which includes the said configuration parameter should be stopped.
